(19) United States
(12) Patent Application Publication
(10) Pub. No.: US 2020/0221205 A1
(43) Pub. Date: Jul. 9, 2020

(54) IN-EAR EARPHONE INCLUDING DRUM SAFETY FILTER PATH

(71) Applicant: BUJEON CO., LTD., Ansan-si (KR)

(72) Inventors: Minkoo PARK, Hwaseong-si (KR); Seungcheol LEE, Ansan-si (KR); Seungwoo CHUN, Hwaseong-si (KR); Jun Ho YOON, Ansan-si (KR)

(21) Appl. No.: 16/689,230

(22) Filed: Nov. 20, 2019

(30) Foreign Application Priority Data
Jan. 4, 2019 (KR) 10-2019-0000991

(51) Int. Cl. H04R 1/10

(52) U.S. Cl. CPC H04R 1/1016; H04R 2460/09; H04R 1/1075

(57) ABSTRACT

Disclosed herein is an in-ear earphone including a drum safety filter (DSF) path, the in-ear earphone including: an earcap; an acoustic structure; and an acoustic unit; wherein the acoustic structure and the acoustic unit include a DSF path configured to remove eardrum pressure during the use of the in-ear earphone by moving air across the front and rear sides of the in-ear earphone.

### CROSS-REFERENCE TO RELATED APPLICATION

This application claims the benefit of Korean Patent Application No. 10-2019-0000991 filed on Jan. 4, 2019, which is hereby incorporated by reference herein in its entirety.

### BACKGROUND

### 1. Technical Field

The present invention relates to an in-ear earphone including a drum safety filter (DSF) path.

### 2. Description of the Related Art

An in-ear earphone is a type of speaker for converting electrical energy into acoustic energy, and enables a user to hear sound by transmitting vibration to the eardrum of an ear without radiating the sound into space.

An in-ear earphone is configured such that it is plugged into an ear of a user so that the sound of a speaker is directly transferred into the ear of the user. It is widely used in portable audio equipment, such as mobile phones, MP3 players, etc., because it enables a user to hear sound with a small output and hardly causes damage to people around in the process of hearing.

Earphones may be basically classified into intra-concha earphones and in-ear earphones according to the way they are plugged into the ear. Intra-concha earphones are worn as if they are worn over the ears, and each person has a different ear shape, which makes space less soundproof. In contrast, in-ear earphones are inserted into the ears of users, and can use earpieces (tips) of various sizes. Accordingly, in-ear earphones are more comfortable to wear and more soundproof than intra-concha earphones.

Although in-ear earphones have an advantage in that they are suitable for use in a noisy place because of their excellent soundproof features, a problem arises in that pressure differences may occur because the ear canals of users and the outside are completely blocked from each other.

### PRIOR ART DOCUMENT

### Patent Document

(Patent document) Korean Patent No. 10-1558091 registered on Sep. 30, 2015

### SUMMARY

An object of the present invention is to provide an in-ear earphone including a DSF path.

Objects of the present invention are not limited to the above-described objects, and other objects that have not been described above will be clearly understood by those skilled in the art from the following description.

In order to accomplish the above object, the present invention provides an in-ear earphone including a drum safety filter (DSF) path, the in-ear earphone including: an earcap; an acoustic structure; and an acoustic unit; wherein the acoustic structure and the acoustic unit include a DSF path configured to remove eardrum pressure during the use of the in-ear earphone by moving air across the front and rear sides of the in-ear earphone.

The acoustic unit may include the DSF path; and the acoustic structure may accommodate the acoustic unit therein, and at least a part of the acoustic structure may be spaced apart from the acoustic unit by a predetermined distance or longer such that air moving through the DSF path communicates.

The acoustic structure may include a center hole configured such that sound and air pass therethrough and a side hole configured to discharge air introduced through the center hole; the acoustic structure may accommodate the acoustic unit, and the acoustic unit may be spaced apart from the acoustic structure by a predetermined distance or longer in order to form the DSF path which allows air, introduced through the center hole, to be discharged through the side hole; and the acoustic structure may be spaced apart from the earcap by a predetermined distance or longer so that air discharged through the side hole is discharged to the rear side of the in-ear earphone.

The acoustic structure may be formed in a plate shape, and may be disposed on one side surface of the acoustic unit; and the acoustic structure may include the DSF path, including: a center hole configured such that sound and air move therethrough; and a discharge path configured to be connected to the center hole, to be spaced apart from and formed around at least a part of a circumference of the center hole, and to discharge air, introduced through the center hole, through one side surface of the acoustic structure.

The acoustic structure may be formed in a plate shape, and may be disposed on one side surface of the acoustic unit; the acoustic unit may include a center hole configured such that sound and air move therethrough, and a side hole configured to discharge air introduced through the center hole; and the acoustic unit may be spaced apart from the acoustic structure by a predetermined distance or longer in order to form a DSF path configured to allow air, introduced through the center hole, to be discharged through the side hole.

The in-ear earphone may further include an ear tip configured to be coupled to one side surface of the earcap; a DSF hole may be formed in one surface of the earcap on which the ear tip is seated; and a part of the ear tip may be spaced apart from the earcap at a location at which the DSF hole is formed such that air flows through the DSF hole.

A DSF hole may be formed to pass through the acoustic radiation hole of the earcap; and the acoustic unit may be spaced apart from the earcap by a predetermined distance or longer such that air introduced through the DSF hole is discharged through the rear surface of the in-ear earphone.

A DSF hole may be formed in an acoustic radiation hole of the earcap; and one opening of the DSF hole may be located on the front side of the in-ear earphone, and the other opening of the DSF hole may be located on a lateral side of the acoustic radiation hole.

A spiral conduit-shaped groove may be formed on at least a part of the outer circumferential surface of an acoustic radiation hole of the earcap; at least one DSF hole may be formed in the ear tip coupling portion of the earcap; and the ear tip may be coupled to the earcap, and a part of the ear tip may be spaced apart from the earcap at a location at which the DSF hole is formed and locations at which both ends of the spiral conduit are formed such that air introduced through the DSF hole is discharged from the in-ear earphone through the spiral conduit.

The in-ear earphone may further include an ear tip configured to be coupled to one side surface of the earcap; at least a part of the gasket of the ear tip may be made of a material which allows air to flow therethrough.

Other specific details of the present invention are included in the detailed description and the accompanying drawings.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing an in-ear earphone including a DSF path according to an embodiment;

FIG. 2 is a diagram showing an in-ear earphone including a DSF path according to another embodiment;

FIG. 3 is a diagram showing an in-ear earphone including a DSF path according to another embodiment;

FIG. 4 is a diagram showing an acoustic structure according to an embodiment;

FIG. 5 is a diagram showing an in-ear earphone including a DSF path according to another embodiment;

FIG. 6 is a diagram showing an in-ear earphone including an ear tip according to an embodiment;

FIG. 7 is a diagram showing an in-ear earphone including a DSF path according to another embodiment;

FIG. 8 is a diagram showing an in-ear earphone including a DSF path according to another embodiment;

FIG. 9 is a diagram showing an in-ear earphone including a spiral conduit according to an embodiment;

FIG. 10 is a diagram showing a spiral conduit structure according to an embodiment; and

FIG. 11 is a diagram showing an in-ear earphone including a special material according to an embodiment.

### DETAILED DESCRIPTION

The advantages and features of the present invention and methods for achieving them will be apparent from embodiments which will be described in detail below in conjunction with the accompanying drawings. However, the present invention is not limited to the embodiments which will be disclosed below, but may be implemented in various different forms. The described embodiments are provided to make the disclosure of the present invention complete and to fully convey the scope of the present invention to those having ordinary skill in the art to which the present invention pertains, and the present invention is defined only by the scope of the attached claims.

The terms used herein are used merely to describe specific embodiments, and are not intended to limit the present invention. A singular expression may include a plural expression unless otherwise defined. In this application, the terms “comprise,” “include,” “comprising,” and “including” and their derivatives are used to designate the presence of one or more features, numbers, steps, operations, components, parts or combinations thereof described in the specification, and should not be understood as excluding the presence or probability of addition of one or more other components. Throughout the specification, like reference symbols denote like components. As used herein, the term “and/or” refers to the inclusion of all combinations of one or more of listed items. The terms “first,” “second,” etc. may be used to describe various components, and components should not be limited by the terms. The terms are used only for the purpose of distinguishing one component from other components. Accordingly, “a first element” described below may be termed “a second element” without departing from the teachings herein.

Unless defined otherwise, all terms used herein (including technical or scientific terms) have the same meanings as the terms generally understood by those skilled in the art to which the present invention pertains. The terms identical to those defined in generally used dictionaries should be interpreted as having meanings identical to contextual meanings of the related art, and are not interpreted as having ideal or excessively formal meanings unless they are definitely defined in the present specification.

Spatially relative terms, such as “beneath,” “below,” “lower,” “above,” “upper,” and the like, may be used herein for ease of description to describe the relationship between one element or feature and another element or feature as shown in the drawings. It will be understood that the spatially relative terms are intended to encompass different orientations of the element or feature in use or operation, in addition to the orientation depicted in the drawings. For example, if an element or feature in the drawings is turned over, the element described as being placed “below” another element or feature may be then placed “above” the other element or feature. Accordingly, the exemplary term “below” can encompass both orientations of above and below. When a component is oriented in another direction, relative descriptions used in the present specification may be interpreted correspondingly.

Embodiments of the present invention will be described in detail below with reference to the accompanying drawings.

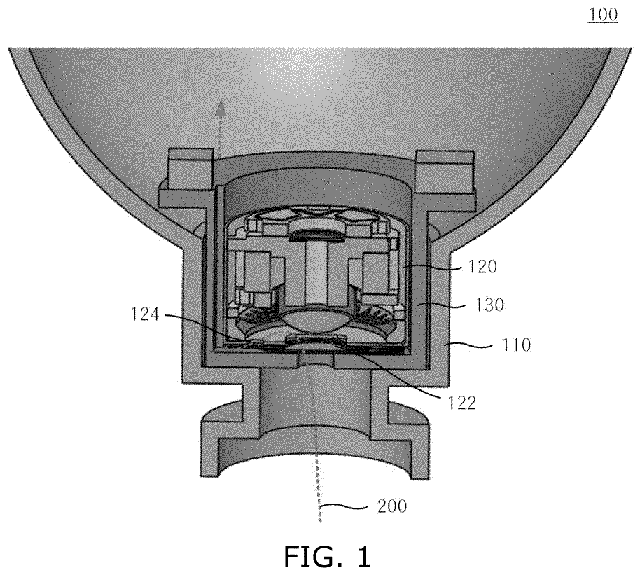

FIG. 1 is a diagram showing an in-ear earphone 100 including a DSF path according to an embodiment.

In the disclosed embodiments, the side of the in-ear earphone 100 which is inserted into the ear canal of a user is referred to as the “front side” of the in-ear earphone 100, and the side opposite to the front side is referred to as the “rear side” of the in-ear earphone 100.

Referring to FIG. 1, the in-ear earphone 100 includes an earcap 110, an acoustic unit 120, and an acoustic structure 130.

In an embodiment, the earcap 110 includes a housing configured to accommodate the components of the earphone 100.

In an embodiment, the acoustic unit 120 includes components of the earphone 100 including a speaker.

In an embodiment, the acoustic structure 130 and the acoustic unit 120 include a DSF path configured to remove eardrum pressure during the use of the in-ear earphone by moving air across the front and rear sides of the in-ear earphone 100.

The location at which the DSF path is formed and the structure of the DSF path may vary depending on an embodiment, and will be described more specifically with reference to the drawings.

Referring to FIG. 1, the acoustic unit 120 includes the DSF path 200.

For example, the acoustic unit 120 includes a center hole 122 and a side hole 124, and allows air, introduced through the center hole 122, to be discharged through the side hole 124.

The acoustic structure 130 accommodates the acoustic unit 120 therein, and at least a part of the acoustic structure may be spaced apart from the acoustic unit by a predetermined distance or longer such that air moving through the DSF path communicates.

For example, a part of the acoustic structure 130 connected to the side hole 124 may be configured to be spaced apart from the acoustic unit 120 such that air discharged through the side hole 124 can be discharged to the rear side of the in-ear earphone 100. The air discharged through the side hole 124 may be discharged to the rear side of the in-ear earphone 100 through the above-described space.

In an embodiment, the high-pitched characteristics of the in-ear earphone 100 may be controlled by adjusting the size of the center hole formed in the acoustic structure 130.

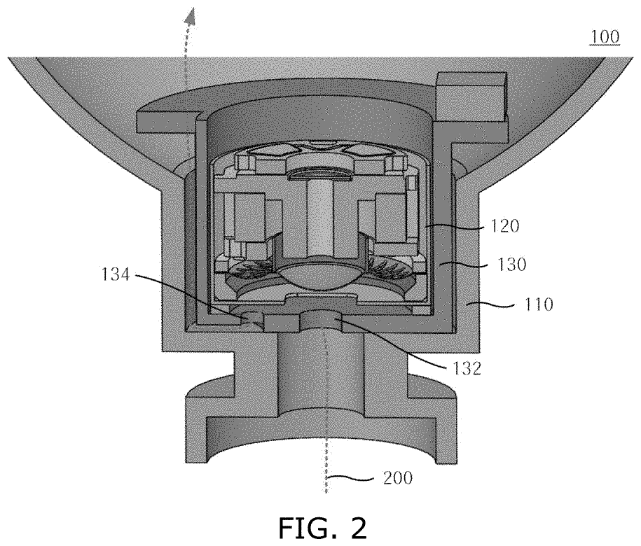

FIG. 2 is a diagram showing an in-ear earphone 100 including a DSF path according to another embodiment.

Referring to FIG. 2, the in-ear earphone 100 includes an earcap 110, an acoustic unit 120, and an acoustic structure 130.

In an embodiment, the acoustic structure 130 includes a center hole 132 configured such that sound and air can pass therethrough and a side hole 134 configured to discharge air introduced through the center hole 132.

In an embodiment, the acoustic structure 130 accommodates the acoustic unit 120, and the acoustic unit 120 is spaced apart from the acoustic structure 130 by a predetermined distance or longer in order to form a DSF path 200 which allows air, introduced through the center hole 132, to be discharged through the side hole 134.

Furthermore, the acoustic structure 130 is spaced apart from the earcap 110 by a predetermined distance or longer such that air discharged through the side hole 134 can be discharged to the rear side of the in-ear earphone 100.

In an embodiment, a mesh may be attached to the tops and bottoms of the holes formed in the acoustic structure 130, in which case the low-pitched characteristics of the in-ear earphone 100 may be controlled based on the density of the mesh.

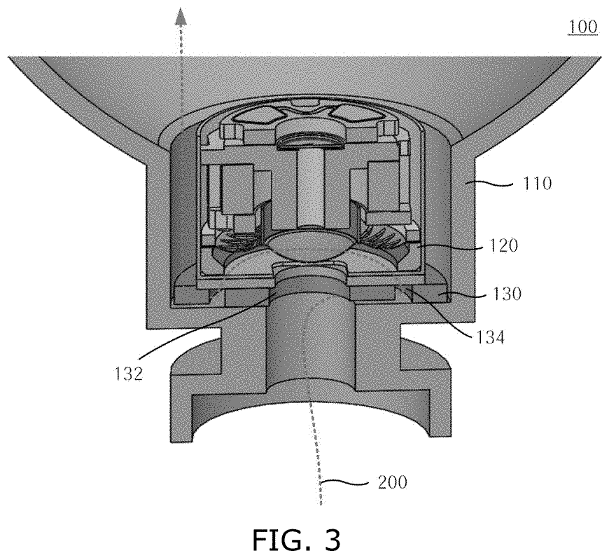

FIG. 3 is a diagram showing an in-ear earphone including a DSF path according to another embodiment.

Referring to FIG. 3, the in-ear earphone 100 includes an earcap 110, an acoustic unit 120, and an acoustic structure 130.

In an embodiment, the acoustic structure 130 is formed in a plate shape, and is disposed on one side surface of the acoustic unit 120. For example, the acoustic structure 130 may be formed in a disk shape, and may be disposed between the acoustic unit 120 and the acoustic radiation hole of the in-ear earphone 100.

In an embodiment, the acoustic structure 130 includes a DSF path 200 including: a center hole 132 configured such that sound and air can move therethrough; and a discharge path 134 configured to be connected to the center hole 132, to be spaced apart from and formed around at least a part of the circumference of the center hole 132, and to discharge air, introduced through the center hole 132, through one side surface of the acoustic structure.

In an embodiment, the high-pitched characteristics of the in-ear earphone 100 may be controlled by adjusting the size of the center hole formed in the acoustic structure 130.

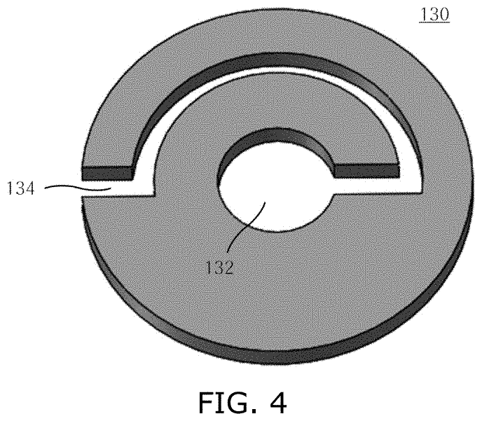

FIG. 4 is a diagram showing an acoustic structure 130 according to an embodiment.

Referring to FIG. 4, the acoustic structure 130 includes a center hole 132 and a discharge path 134 to be spaced apart from and formed around at least a part of the circumference of the center hole 132 and to discharge air, introduced through the center hole 132, through one side surface of the acoustic structure.

The shape of the discharge path 134 is not limited to the shape shown in FIG. 4.

When the discharge path 134 of the shape shown in FIG. 4 is used, advantages arise in that the path of air may be secured and the entry of external noise may be blocked.

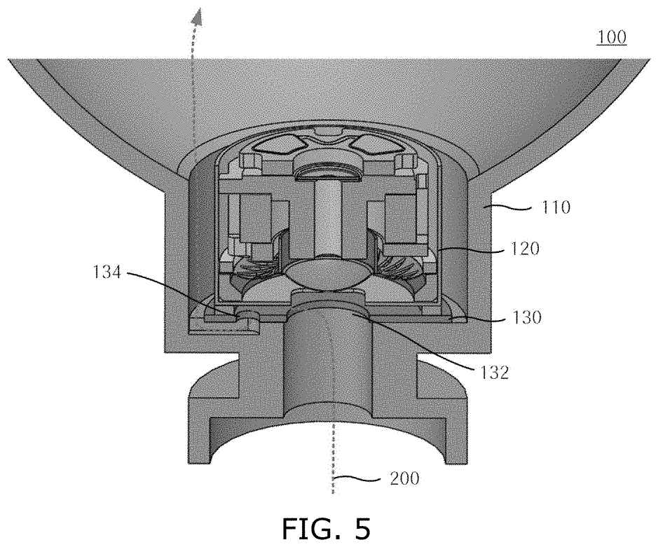

FIG. 5 is a diagram showing an in-ear earphone 100 including a DSF path according to another embodiment.

Referring to FIG. 5, the in-ear earphone 100 includes an earcap 110, an acoustic unit 120, and an acoustic structure 130.

In an embodiment, the acoustic structure 130 is formed in a plate shape, and is disposed on one side surface of the acoustic unit 120.

In an embodiment, the acoustic unit 120 includes a center hole 132 configured such that sound and air can move therethrough, and a side hole 134 configured to discharge air introduced through the center hole 132.

In an embodiment, the acoustic unit 120 is spaced apart from the acoustic structure 130 by a predetermined distance or longer in order to form a DSF path 200 configured to allow air, introduced through the center hole 132, to be discharged through the side hole 134.

In an embodiment, a mesh may be attached to the tops and bottoms of the holes formed in the acoustic structure 130, in which case the low-pitched characteristics of the in-ear earphone 100 may be controlled based on the density of the mesh.

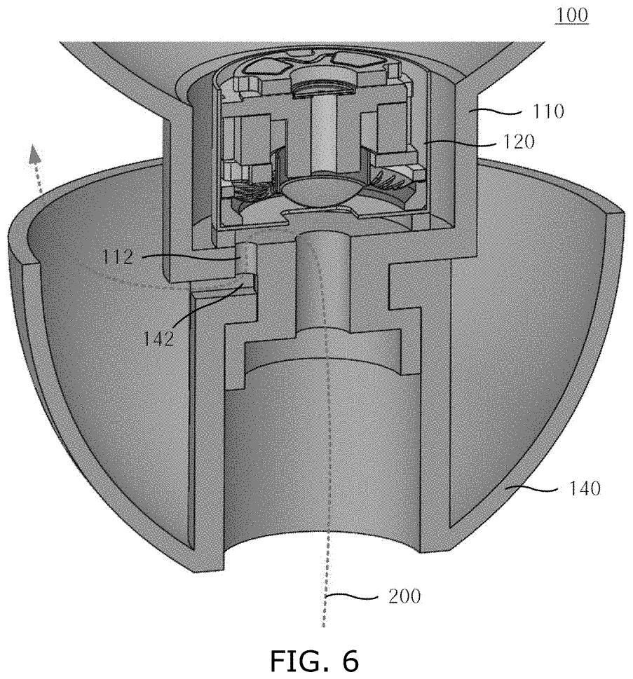

FIG. 6 is a diagram showing an in-ear earphone 100 including an ear tip according to an embodiment.

Referring to FIG. 6, the in-ear earphone 100 includes an earcap 110, an acoustic unit 120, and an acoustic structure 130.

Furthermore, the in-ear earphone 100 further includes an ear tip 140 configured to be coupled to one side surface of the earcap 110.

In an embodiment, a DSF hole 112 is formed in one surface of the earcap 110 on which the ear tip 140 is seated.

In an embodiment, a space 142 configured such that air communicates therethrough is provided in such a manner that a part of the ear tip 140 is spaced apart from the earcap 110 at a location at which the DSF hole 112 is formed such that air can flow through the DSF hole 112.

In an embodiment, a mesh may be attached to the top and bottom of the DSF hole 112, in which case the low-pitched characteristics of the in-ear earphone 100 may be controlled based on the density of the mesh.

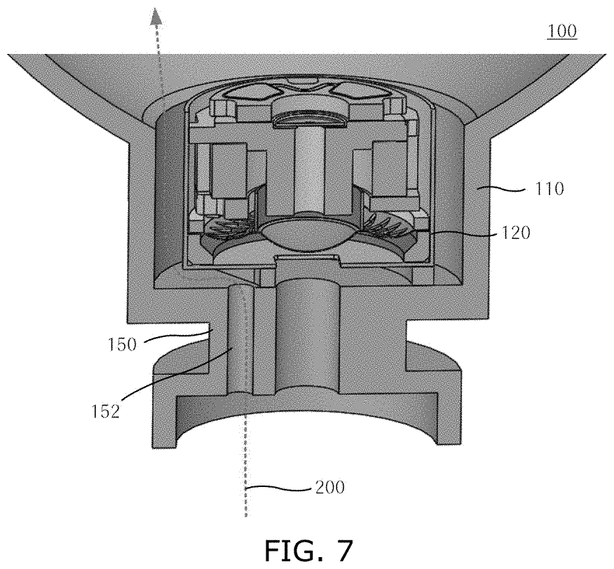

FIG. 7 is a diagram showing an in-ear earphone 100 including a DSF path according to another embodiment.

Referring to FIG. 7, the in-ear earphone 100 includes an earcap 110, an acoustic unit 120, and an acoustic structure 130.

In an embodiment, a DSF hole 152 is formed to pass through the acoustic radiation hole 150 of the earcap 110.

In an embodiment, the acoustic unit 120 may be spaced apart from the earcap 110 by a predetermined distance or longer such that air introduced through the DSF hole 152 can be discharged through the rear surface of the in-ear earphone 100.

In an embodiment, a mesh may be attached to the top and bottom of the DSF hole 152, in which case the low-pitched characteristics of the in-ear earphone 100 may be controlled based on the density of the mesh.

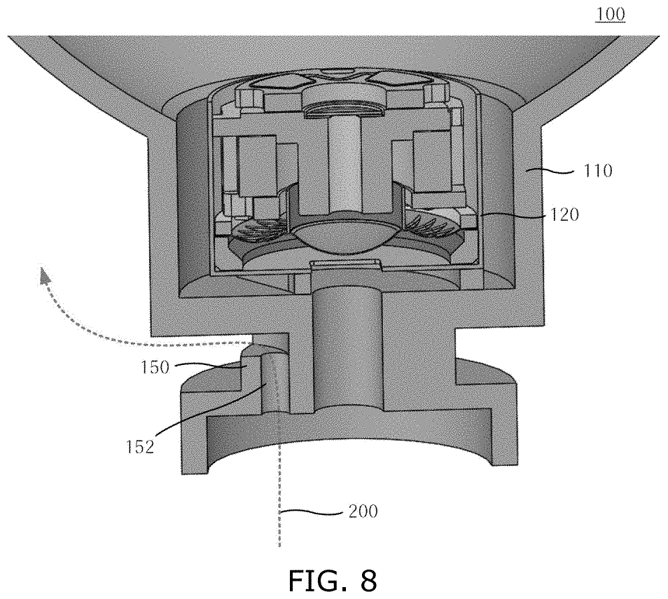

FIG. 8 is a diagram showing an in-ear earphone 100 including a DSF path according to another embodiment.

Referring to FIG. 8, the in-ear earphone 100 includes an earcap 110, an acoustic unit 120, and an acoustic structure 130.

In an embodiment, a DSF hole 152 is formed in the acoustic radiation hole 150 of the earcap 110.

In an embodiment, one opening of the DSF hole 152 is located on the front side of the in-ear earphone 100, and the other opening of the DSF hole 152 is located on a lateral side of the acoustic radiation hole 150.

In an embodiment, a mesh may be attached to the top and bottom of the DSF hole 152, in which case the low-pitched characteristics of the in-ear earphone 100 may be controlled based on the density of the mesh.

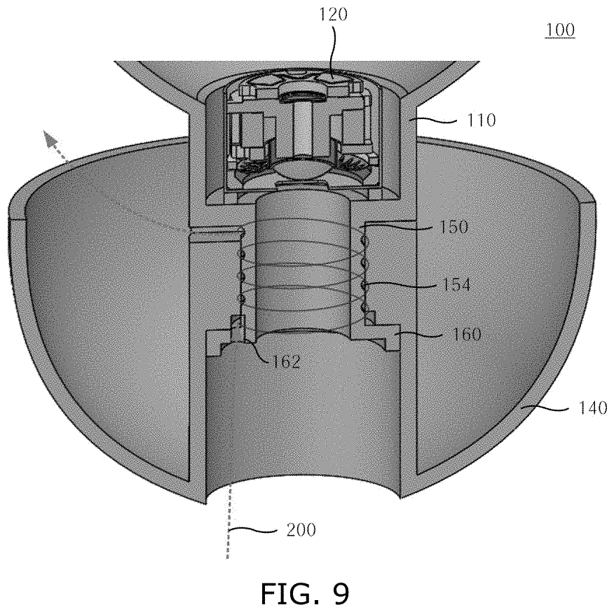

FIG. 9 is a diagram showing an in-ear earphone 100 including a spiral conduit according to an embodiment.

Referring to FIG. 9, the in-ear earphone 100 includes an earcap 110, an acoustic unit 120, and an acoustic structure 130.

Furthermore, the in-ear earphone 100 further includes an ear tip 140 configured to be coupled to one side surface of the earcap 110.

In an embodiment, a spiral conduit-shaped groove 154 is formed on at least a part of the outer circumferential surface of the acoustic radiation hole 150 of the earcap 110.

In an embodiment, at least one DSF hole 162 is formed in the ear tip coupling portion 160 of the earcap 110.

In an embodiment, the ear tip 140 is coupled to the earcap 110, and a part of the ear tip 140 is spaced apart from the earcap 110 at a location at which the DSF hole 162 is formed and locations at which both ends of the spiral conduit 154 are formed such that air introduced through the DSF hole 162 can be discharged from the in-ear earphone 100 through the spiral conduit 154.

In other words, a DSF path 200 is formed such that air can move from the DSF hole 162 through a space formed between the outer circumferential surface of the acoustic radiation hole 150 and the ear tip 140 due to the spiral conduit 154.

In an embodiment, the low-pitched characteristics of the in-ear earphone 100 may be controlled according to the length and sectional area of the spiral conduit 154.

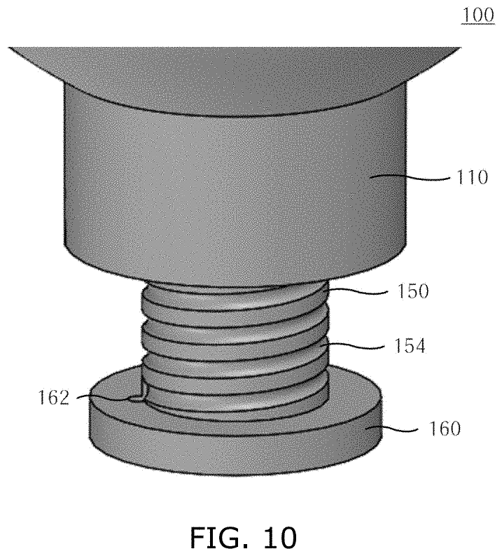

FIG. 10 is a diagram showing a spiral conduit structure according to an embodiment.

Referring to FIG. 10, there are shown the earcap 110 of an in-ear earphone 100 and a spiral conduit-shaped groove 154 formed in the outer circumferential surface of the acoustic radiation hole 150.

Furthermore, referring to FIG. 10, there are shown an ear tip coupling portion 160 and a DSF hole 162 formed in the ear tip coupling portion 160.

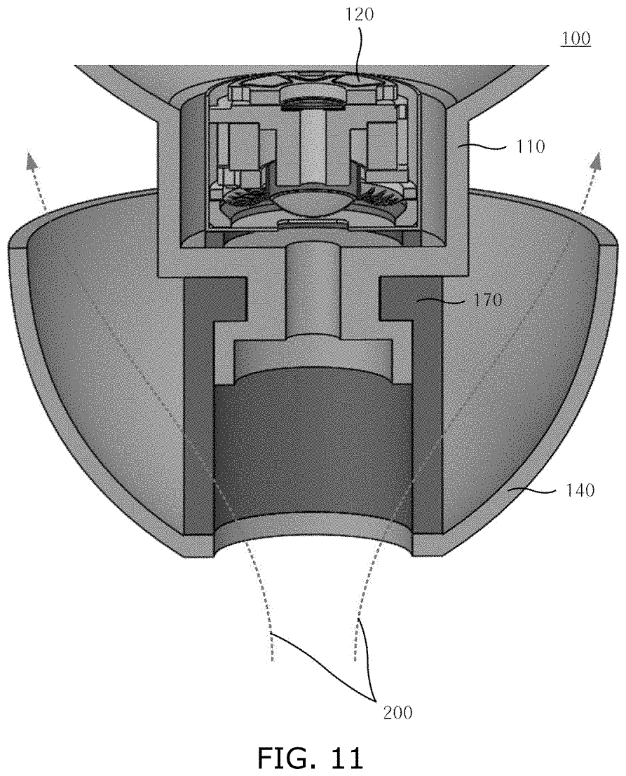

FIG. 11 is a diagram showing an in-ear earphone 100 including a special material according to an embodiment.

Referring to FIG. 11, the in-ear earphone 100 includes an earcap 110, an acoustic unit 120, and an acoustic structure 130.

Furthermore, the in-ear earphone 100 further includes an ear tip 140 configured to be coupled to one side surface of the earcap 110.

In an embodiment, at least a part of the gasket 170 of the ear tip 140 is made of a material which allows air to flow therethrough.

Accordingly, in the in-ear earphone 100, a DSF path 200 configured such that air flows therethrough may be formed through the gasket 170.

In an embodiment, the low-pitched characteristics of the in-ear earphone 100 may be controlled based on the area and thickness of a material which constitutes the gasket 170.

According to the disclosed embodiments, an advantage arises in that a difference in air pressure which may occur during the use of an in-ear earphone can be removed by providing the DSF path, through which air can move, across the front and/or rear sides of the in-ear earphone.

Advantages of the present invention are not limited to the above-described advantage, and other advantages which have not been described above will be clearly understood by those skilled in the art from the following description.

Although the embodiments of the present invention have been described with reference to the accompanying drawings, it will be understood by those having ordinary skill in the art to which the present invention pertains that the present invention may be practiced in other specific forms without departing from the technical spirit or essential feature of the present invention. Therefore, it should be understood that the embodiments described above are merely illustrative but not limitative in all aspects.

What is claimed is:

1. An in-ear earphone including a drum safety filter (DSF) path, the in-ear earphone comprising:
an earcap;
an acoustic structure; and
an acoustic unit;
wherein the acoustic structure and the acoustic unit comprise a DSF path configured to remove eardrum pressure during use of the in-ear earphone by moving air across front and rear sides of the in-ear earphone.

2. The in-ear earphone of claim 1, wherein:
the acoustic unit comprises the DSF path; and
the acoustic structure accommodates the acoustic unit therein, and at least a part of the acoustic structure is spaced apart from the acoustic unit by a predetermined distance or longer such that air moving through the DSF path communicates.

3. The in-ear earphone of claim 1, wherein:
the acoustic structure comprises a center hole configured such that sound and air pass therethrough and a side hole configured to discharge air introduced through the center hole;
the acoustic structure accommodates the acoustic unit, and the acoustic unit is spaced apart from the acoustic structure by a predetermined distance or longer in order to form the DSF path which allows air, introduced through the center hole, to be discharged through the side hole; and
the acoustic structure is spaced apart from the earcap by a predetermined distance or longer such that air discharged through the side hole is discharged to the rear side of the in-ear earphone.

4. The in-ear earphone of claim 1, wherein:
the acoustic structure is formed in a plate shape, and is disposed on one side surface of the acoustic unit; and
the acoustic structure comprises the DSF path, including:
a center hole configured such that sound and air move therethrough; and a discharge path configured to be connected to the center hole, to be spaced apart from and formed around at least a part of a circumference of the center hole, and to discharge air, introduced through the center hole, through one side surface of the acoustic structure.

5. The in-ear earphone of claim 1, wherein:
the acoustic structure is formed in a plate shape, and is disposed on one side surface of the acoustic unit;
the acoustic unit comprises a center hole configured such that sound and air move therethrough, and a side hole configured to discharge air introduced through the center hole; and
the acoustic unit is spaced apart from the acoustic structure by a predetermined distance or longer in order to form a DSF path configured to allow air, introduced through the center hole, to be discharged through the side hole.

6. The in-ear earphone of claim 1, further comprising an ear tip configured to be coupled to one side surface of the earcap;
wherein a DSF hole is formed in one surface of the earcap on which the ear tip is seated; and
wherein a part of the ear tip is spaced apart from the earcap at a location at which the DSF hole is formed such that air flows through the DSF hole.

7. The in-ear earphone of claim 1, wherein:
a DSF hole is formed to pass through an acoustic radiation hole of the earcap; and
the acoustic unit is spaced apart from the earcap by a predetermined distance or longer such that air introduced through the DSF hole is discharged through the rear surface of the in-ear earphone.

8. The in-ear earphone of claim 1, wherein:
a DSF hole is formed in an acoustic radiation hole of the earcap; and
one opening of the DSF hole is located on the front side of the in-ear earphone, and a remaining opening of the DSF hole is located on a lateral side of the acoustic radiation hole.

9. The in-ear earphone of claim 1, wherein:
a spiral conduit-shaped groove is formed on at least a part of an outer circumferential surface of an acoustic radiation hole of the earcap;
at least one DSF hole is formed in an ear tip coupling portion of the earcap; and
the ear tip is coupled to the earcap, and a part of the ear tip is spaced apart from the earcap at a location at which the DSF hole is formed and locations at which both ends of the spiral conduit are formed such that air introduced through the DSF hole is discharged from the in-ear earphone through the spiral conduit.

10. The in-ear earphone of claim 1, further comprising an ear tip configured to be coupled to one side surface of the earcap;
wherein at least a part of a gasket of the ear tip is made of a material which allows air to flow therethrough.
